(19) United States
(12) Patent Application Publication
(10) Pub. No.: US 2025/0369485 A1
(43) Pub. Date: Dec. 4, 2025

(54) MOUNTING STRUCTURE FOR DRIVE SHAFT

(71) Applicants: HYUNDAI MOTOR COMPANY, Seoul (KR); KIA CORPORATION, Seoul (KR)

(72) Inventors: Seung Won KIM, Hwaseong-si (KR); Juneyoung KIM, Hwaseong-si (KR); Kwang Jae LEE, Hwaseong-si (KR); Ki Suk HAN, Hwaseong-si (KR)

(73) Assignees: HYUNDAI MOTOR COMPANY, Seoul (KR); KIA CORPORATION, Seoul (KR)

(21) Appl. No.: 18/960,711

(22) Filed: Nov. 26, 2024

(30) Foreign Application Priority Data
May 30, 2024 (KR) 10-2024-0070475

(51) Int. Cl. F16D 1/08

(52) U.S. Cl. CPC F16D 1/0864

(57) ABSTRACT

A mounting structure for a drive shaft assembly, which is configured to mount a drive shaft assembly including an outer wheel to a differential unit, includes a stem portion protruding from the outer wheel and connected to the differential unit, and having a cut line formed along the axial direction at the free end portion, and a wedge stay provided so as to be wedge-attachable along the axial direction of the stem portion on the cut line.

### CROSS-REFERENCE TO RELATED APPLICATION

This application claims priority to and the benefit of Korean Patent Application No. 10-2024-0070475 filed in the Korean Intellectual Property Office on May 30, 2024, the entire contents of which are incorporated herein by reference.

### BACKGROUND

### (a) Field

The present disclosure relates to a mounting structure for a drive shaft assembly. More particularly, the present disclosure relates to a mounting structure for a drive shaft assembly for improving backlash.

### (b) Description of the Related Art

Generally, for luxury passenger vehicles, rear wheel drive is applied. This rear wheel drive system transmits power to the drive wheels through a power delivery system connected from the front to the rear of the vehicle. This power delivery system is provided with a propeller shaft assembly, a differential unit, and a drive shaft assembly.

Here, the drive shaft assembly engages the side gear of the differential unit, and power output through the side gear can be transmitted to the driving wheels. The connection method of the drive shaft assembly and the differential unit can be divided into, for example, stem type and bolting type.

According to the stem type connection method, the stem portion formed on the outer ring of the drive shaft assembly engages with the side gear. These stems can be spline coupled with side gears via serrations.

However, the stem type connection method can cause backlash due to the clearance that forms between the serration of the stem and the gear teeth of the side gear. This backlash not only causes driving noise in the vehicle, but also acts as a factor in deteriorating acceleration responsiveness, gear shift responsiveness, and shift feel.

And, the bolting type connection method is a connection method to prevent the occurrence of backlash, and connects the drive shaft assembly and the differential unit using an adaptor (a person of an ordinary skill in the art is also commonly called a ‘companion shaft’).

Here, the adaptor may be provided in the form of a cylinder shape with serrations formed on the exterior circumference surface, as an example. These adaptors can be press-fitted to the gear teeth of the side gear through serrations and bolted to the outer race of the drive shaft assembly.

However, although the bolting type connection can improve the occurrence of backlash, it is necessary to increase the size of the outer ring to allow bolting engagement between the adaptor and the outer ring.

Therefore, the bolting type connection method is disadvantageous to the vehicle package layout, can cause interference with surrounding parts, and can increase manufacturing cost and weight.

The information contained in this background section has been prepared to promote understanding of the background of the disclosure and may include matters that are not prior art already known to those skilled in the art.

### SUMMARY

The present disclosure attempts to provide a mounting structure for a drive shaft assembly that can improve backlash due to gear connection between a differential unit and a drive shaft assembly without increasing the size of the drive shaft assembly.

A mounting structure for a drive shaft assembly, which is configured to mount a drive shaft assembly including an outer wheel to a differential unit, the mounting structure according to an embodiment may include a stem portion protruding from the outer wheel and connected to the differential unit, and having a cut line formed along the axial direction at the free end portion, and a wedge stay provided so as to be wedge-attachable along the axial direction of the stem portion on the cut line.

The mounting structure according to an embodiment may further include a wedge handling unit mounted on the stem portion to engage the wedge stay on the cut line.

The stem portion may be extended outward by the wedge stay which is joined to the cut line.

A serration formed on the exterior circumference surface of the stem portion may adhere to the side gear of the differential unit.

The cut line may extend from the free end portion of the stem portion to a predetermined section along the axial direction.

The stem portion may include a guide rail formed to connect the cut line and a connecting end portion connected to the outer wheel.

The stem portion may include wedge deformable parts cut along the axial direction by the cut line.

The stem portion may include a wedge connection groove formed in the free end portion direction of the wedge deformable parts.

The wedge stay may include a wedge body portion fitted along the axial direction of the cut line, a wedge protrusion formed at one end of the wedge body portion and joined to the wedge connection groove, and a screw tap part formed on the other end of the wedge body portion.

The wedge body portion may be formed as a ‘U’ shaped plate type.

The wedge connection groove may be formed with a predetermined gradient angle θ1, whose cross-section decreases from the free end portion of the stem portion to the connecting end portion direction.

The wedge protrusion may be formed by a gradient angle θ2 greater than the gradient angle θ1 of the wedge connection groove, whose cross-section decreases from one end of the wedge body portion to the other.

The wedge handling unit may include a fastening nut which is rotatably mounted on the connecting end portion side of the stem portion and screw-connected with the screw tap part.

The wedge handling unit may further include a nut stopper in the shape of a ring provided on the connecting end portion side of the stem portion.

The nut stopper may include at least one key protrusion formed to protrude along the interior diameter direction on the inner surface so as to fit along the axial direction of the stem portion on the cut line, and at least one guide groove formed on the inner surface to guide the wedge body portion.

A key groove connected to the cut line may be formed on the connecting end portion side of the stem portion.

The at least one key protrusion may be coupled to the key groove along the rotating direction of the fastening nut.

By the rotation of the fastening nut that is screw-connected with the screw tap part, the wedge stay may move from the free end portion to the connecting end portion of the stem portion.

The wedge protrusion may be joined to the wedge connection groove by the movement of the wedge stay.

According to an embodiment of a mounting structure for a drive shaft assembly, the backlash between the differential unit and the drive shaft assembly can be improved, thereby minimizing the occurrence of backlash noise.

In addition, the effects that can be obtained or expected from embodiments of the present disclosure are directly or implicitly disclosed in the detailed description of the embodiments of the present disclosure. That is, various effects predicted according to embodiments of the present disclosure will be disclosed in the detailed description to be provided later.

### BRIEF DESCRIPTION OF THE DRAWINGS

These drawings are intended for reference in explaining exemplary embodiments of the present disclosure, and therefore, the technical ideas of the present disclosure should not be construed as being limited to the accompanying drawings.

FIG. 1 is a side view illustrating a mounting structure for a drive shaft assembly according to an embodiment.

FIG. 2 is a perspective view illustrating a mounting structure for a drive shaft assembly according to an embodiment.

FIG. 3 and FIG. 4 are exploded perspective views illustrating a mounting structure for a drive shaft assembly according to an embodiment.

FIGS. 5, 6, 7, and 8 are drawings illustrating a stem portion applied to a mounting structure for a drive shaft assembly according to an embodiment.

FIGS. 9, 10A, 10B, and 11 are drawings illustrating a wedge stay applied to a mounting structure for a drive shaft assembly according to an embodiment.

FIG. 12 and FIG. 13 are exploded perspective views illustrating a wedge handling unit applied to a mounting structure for a drive shaft assembly according to an embodiment.

FIG. 14 is a drawing showing a nut stopper of a wedge handling unit applied to a mounting structure for a drive shaft assembly according to an embodiment.

FIG. 15A and FIG. 15B are cutaway views showing the connection process of a wedge stay and a wedge handling unit applied to a mounting structure for a drive shaft assembly according to an embodiment.

FIG. 16 is a cutaway view showing the completed connection of a wedge stay and a wedge handling unit applied to a mounting structure for a drive shaft assembly according to an embodiment.

FIGS. 17, 18, 19, 20, 21, 22, 23, and 24 are drawings for explaining the assembly process and operation of a mounting structure for a drive shaft assembly according to an embodiment.

FIG. 25A and FIG. 25B are drawings illustrating the operational effects of a mounting structure for a drive shaft assembly according to an embodiment.

It should be understood that the drawings referenced above are not necessarily drawn to scale, but rather present rather simplified representations of various preferred features illustrating the basic principles of the present disclosure. For example, specific design features of the present disclosure, including specific dimensions, orientations, locations, and shapes, will be determined in part by the particular intended application and usage environment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

The terminology used herein is for the purpose of describing particular embodiments only and is not intended to limit the present disclosure. As used herein, the singular forms are intended to include the plural forms as well, unless the context clearly indicates otherwise.

In addition, the names of the components in the detailed description below are distinguished as first, second, etc., to distinguish them as they have the same relationship, and the description below is not necessarily limited to that order.

It should also be understood that the terms “comprises” and/or “comprising” as used herein indicate the presence of stated features, integers, steps, operations, elements and/or components, but do not preclude the presence or addition of one or more other features, integers, steps, operations, components, and/or groups thereof.

As used in this specification, the term ‘and/or’ includes any one or all combinations of one or more of the associated listed items.

The term “connected” in this specification indicates a physical relationship between two components in which the components are directly connected to each other by means of welding, rivets, self-piercing rivets (SPR), flow drill screws (FDS), structural adhesives, etc., or indirectly connected through one or more intermediate components.

As used herein, the terms ‘vehicle’, ‘vehicular’, ‘automobile’ or other similar terms used herein generally include passenger automobiles, including passenger cars, sport utility vehicles (SUVs), buses, trucks, various commercial vehicles, and also include hybrid automobiles, electric automobiles, hybrid-electric automobiles, electric-based Purpose Built Vehicles (PBVs), hydrogen-powered vehicles and other alternative fuel vehicles (e.g., fuels derived from resources other than petroleum).

Hereinafter, embodiments of the present disclosure will be described in detail with reference to the accompanying drawing.

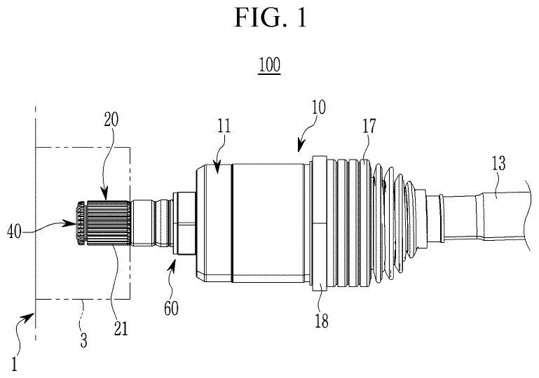

FIG. 1 is a side view illustrating a mounting structure for a drive shaft assembly according to an embodiment.

Referring to FIG. 1, a mounting structure for a drive shaft assembly 100 according to an embodiment may be applied to a drive system of a vehicle, for example, a drive system of a rear wheel drive type.

The rear wheel drive type drivetrain can transmit the driving torque of the engine or drive motor to the drive wheels through the power delivery system of the propeller shaft (not shown), a differential unit 1, and a drive shaft assembly 10.

In this specification, the reference direction for explaining the components below may be set as the front-rear direction of the body (e.g., body length direction), the width direction (e.g., left-right direction), and the up-down direction (e.g., height direction) based on the body.

In this specification, the ‘upper part’, ‘upper portion’, ‘top’ or ‘upper surface’ of a component indicates an end, section, or surface of the component that is relatively upper in the drawing, and the ‘lower part’, ‘lower portion’, or ‘lower surface’ of a component indicates an end, section, or surface of the component that is relatively lower in the drawing.

Additionally, in the specification, the term “end” of a component (e.g., one end, the other end, or both ends, etc.) indicates an end of the component in any one direction, and the term “end portion” of a component (e.g., one end portion, the other end portion, both end portions, a front end portion, or a rear end portion, etc.) indicates a portion of the component that includes that end.

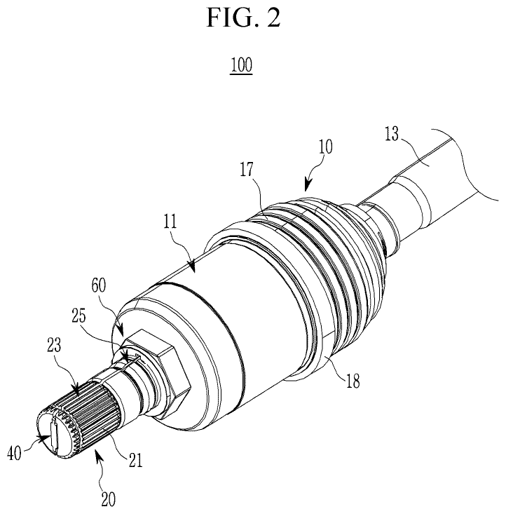

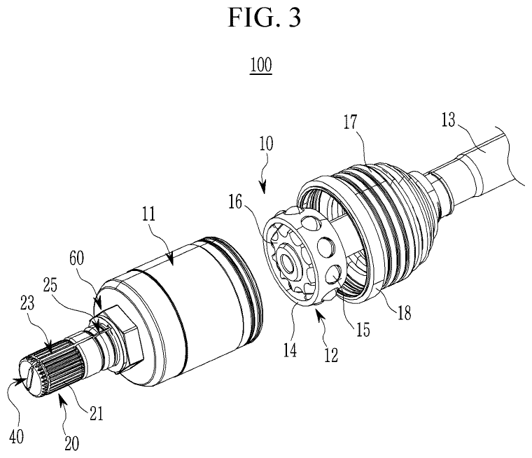

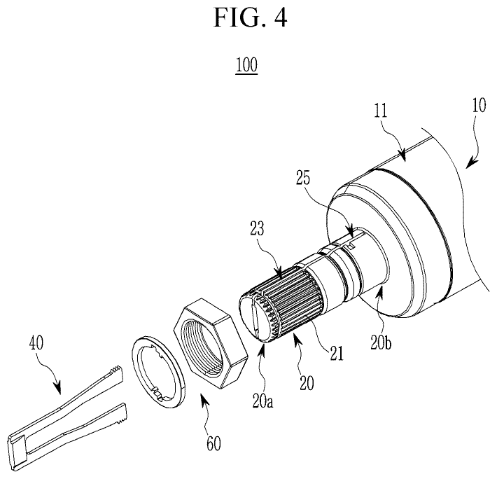

FIG. 2 is a perspective view illustrating a mounting structure for a drive shaft assembly according to an embodiment, and FIG. 3 and FIG. 4 are exploded perspective views illustrating a mounting structure for a drive shaft assembly according to an embodiment.

Referring to FIG. 1 to FIG. 4, the drive shaft assembly 10 applied to a mounting structure for a drive shaft assembly 100 according to an embodiment includes an outer wheel 11 and a joint 12.

The outer wheel 11 is connected to a side gear 3 of the differential unit 1. The joint 12 is mounted on a shaft 13 and is connected to the inner side of the outer wheel 11 through an open end of the outer wheel 11.

The drive shaft assembly 10 may be spline coupled along the axial direction with the side gear 3 of the differential unit 1 via the outer wheel 11.

The outer wheel 11 and joint 12 may be a constant velocity joint unit known to those skilled in the art. The joint 12 includes, in one example, an inner wheel 14, a plurality of balls 15, and a cage 16.

The joint 12 is joined via balls 15 to grooves (not shown) formed along a straight line direction (e.g., vehicle width direction) on the inner surface of outer wheel 11.

The drive shaft assembly 10 includes a boot 17 attached to the shaft 13 with the joint 12 located internally. The boot 17 is connected to the outer wheel 11 via an open end, and the open end of the boot 17 is clamped to the outer wheel 11 via a clamp band 18.

The basic configuration and function of the drive shaft assembly 10 are obvious to those skilled in the art, and thus a detailed description is omitted.

The mounting structure for a drive shaft assembly 100 according to an embodiment is configured to mount the drive shaft assembly 10 to the differential unit 1.

The mounting structure for a drive shaft assembly 100 according to an embodiment provides a structure capable of improving backlash resulting from gear connection between the differential unit 1 and the drive shaft assembly 10.

The mounting structure for a drive shaft assembly 100 according to an embodiment includes a stem portion 20, a wedge stay 40, and a wedge handling unit 60.

In an embodiment, the stem portion 20 protrudes along the axial direction (e.g., vehicle width direction) to a closed end opposite the open end of the outer wheel 11. The stem portion 20 may be connected to the side gear 3 of the differential unit 1.

The stem portion 20 includes a serration 21 formed on an exterior circumference surface along the axial direction. The serration 21 may be spline coupled along the axial direction of the side gear 3 of the differential unit 1 and the stem portion 20.

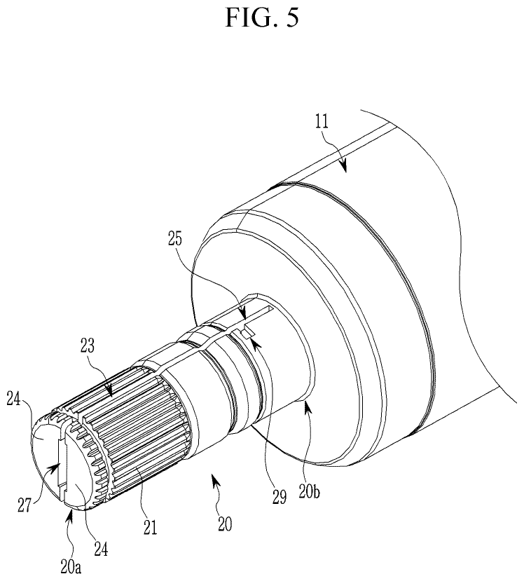

FIG. 5 to FIG. 8 are drawings illustrating a stem portion applied to a mounting structure for a drive shaft assembly according to an embodiment.

Referring to FIG. 5 to FIG. 8, the stem portion 20 according to an embodiment may further include a cut line 23, a guide rail 25, a wedge connection groove 27, and a key groove 29.

In this specification, the protruding end (or end portion) of the stem portion 20 may be defined as the free end portion, and the connecting end of the stem portion 20 connected to the closed end of the outer wheel 11 may be defined as the connecting end portion.

The cut line 23 is formed along the axial direction from the free end portion 20a of the stem portion 20 toward the connecting end portion 20b. The cut line 23 extends from the free end portion 20a of the stem portion 20 to the connecting end portion 20b along the axial direction to a predetermined section.

As the cut line 23 is formed in the stem portion 20 as described above, the stem portion 20 may include wedge deformable parts 24 cut along the axial direction at a certain section by the cut line 23. Although the drawing shows that two wedge deformable parts 24 are formed, this is not a limitation, and three or more wedge deformable parts 24 may be formed.

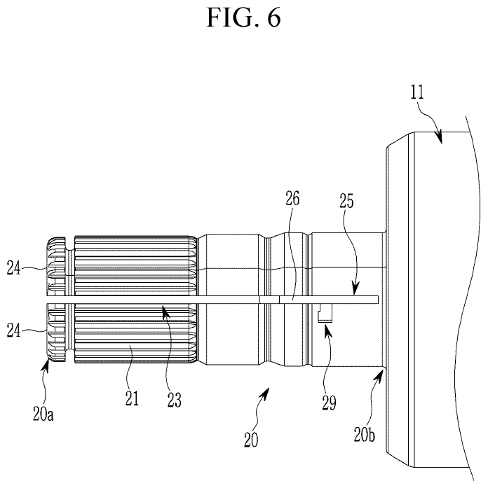

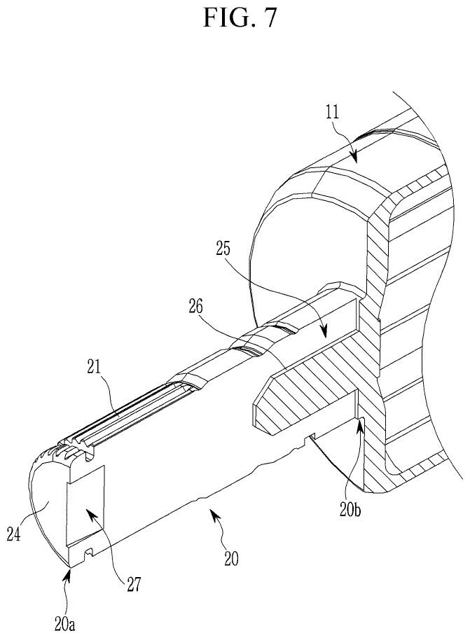

The guide rail 25 is configured to connect the cut line 23 and the connecting end portion 20b, as shown in FIG. 6 and FIG. 7. The guide rail 25 is formed on the upper and lower sides of the stem portion 20 on the connecting end portion 20b side with the drawing as a reference. That is, the guide rail 25 may be formed symmetrically to the stem portion 20. The guide rail 25 may be formed by a guide portion 26 connected to a connecting end portion 20b on the inner side of the cut line 23.

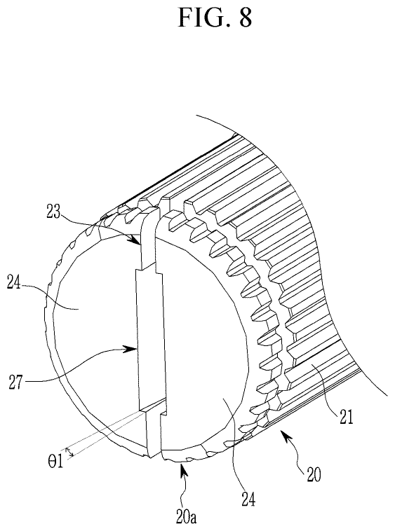

The wedge connection groove 27, as shown in FIG. 7 and FIG. 8, is formed in the wedge deformable parts 24 at the free end portion 20a of the stem portion 20 and is connected to the cut line 23.

The wedge connection groove 27 may be formed with a predetermined gradient angle θ1. That is, the wedge connection groove 27 is formed in a shape in which its cross-section decreases from the free end portion 20a of the stem portion 20 to the connecting end portion 20b.

And, the key groove 29 is formed on the connecting end portion 20b side of the stem portion 20. The key groove 29 is connected to the cut line 23 and the guide rail 25. The key groove 29 is connected to the guide rail 25 along the circumference direction of the stem portion 20 on the connecting end portion 20b side of the stem portion 20.

Referring to FIG. 1 to FIG. 4, in an embodiment, the wedge stay 40 is provided such that the wedge may be engaged with the cut line 23 of the stem portion 20 and the guide rail 25 along the axial direction of the stem portion 20.

The wedge stay 40 expands the exterior diameter of the stem portion 20 by being wedge-joined to the cut line 23 and the guide rail 25, and is designed to bring the serration 21 of the stem portion 20 into close contact with the side gear 3 of the differential unit 1.

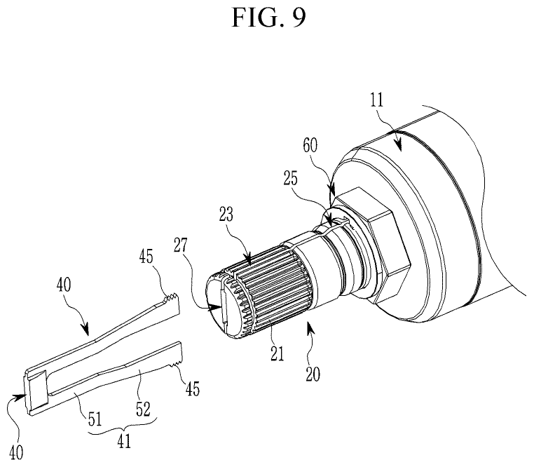

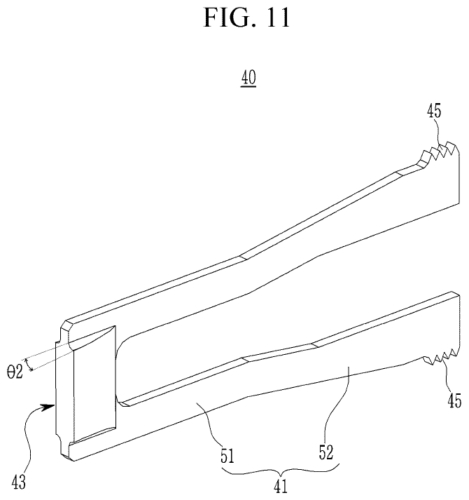

FIG. 9 to FIG. 11 are drawings illustrating a wedge stay applied to a mounting structure for a drive shaft assembly according to an embodiment.

Referring to FIG. 9 to FIG. 11, the wedge stay 40 according to an embodiment includes a wedge body portion 41, a wedge protrusion 43, and a screw tap part 45.

The wedge body portion 41 is provided as a plate type with a roughly ‘U’ shape. The wedge body portion 41 is fitted along the cut line 23 of the stem portion 20 and the guide rail 25 along the axial direction.

The wedge body portion 41 includes a first portion 51 and a second portion 52. The first portion 51 is a portion where the wedge body portion 41 is connected, and the second portion 52 is a portion extended from the first portion 51.

The first portion 51 is placed on the cut line 23. The second portion 52 is placed on the guide rail 25 and supported on the guide portion 26 mentioned above.

The wedge protrusion 43 is formed on the first portion 51 of the wedge body portion 41 and is wedge-connected to the wedge connection groove 27 of the stem portion 20.

The wedge protrusion 43 is formed with a gradient angle θ2 that is larger than the gradient angle (θ1, see FIG. 8) of the wedge connection groove 27. That is, the wedge protrusion 43 is formed in a shape in which the cross-section becomes smaller from one end to the other of the wedge body portion 41.

The screw tap part 45 is formed along the length direction of the wedge body portion 41 on the second portion 52 of the wedge body portion 41.

Referring to FIG. 1 to FIG. 4, in an embodiment, the wedge handling unit 60 is configured to wedge-attach a wedge stay 40 to the cut line 23 of the stem portion 20 and the guide rail 25 and to secure the wedge stay 40 to the stem portion 20.

The wedge handling unit 60 is provided on the connecting end portion 20b of the stem portion 20.

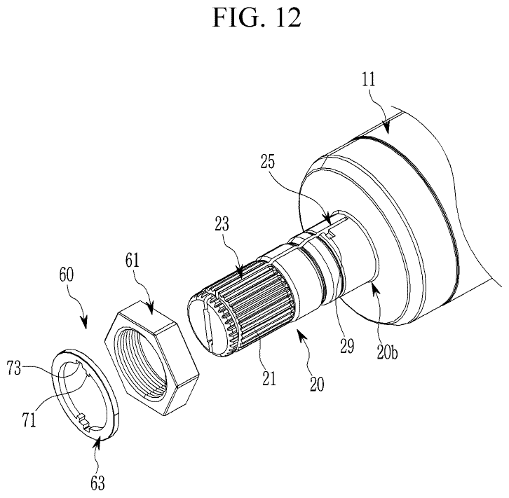

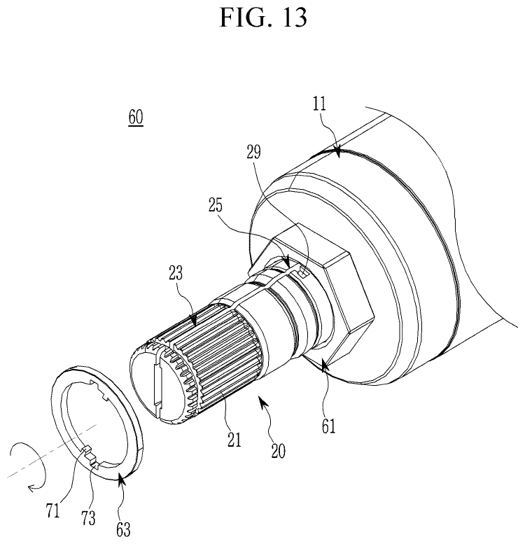

FIG. 12 and FIG. 13 are exploded perspective views illustrating a wedge handling unit applied to a mounting structure for a drive shaft assembly according to an embodiment.

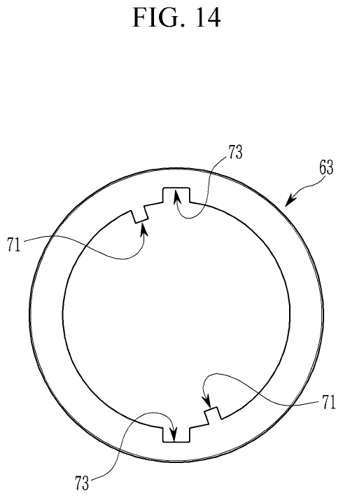

FIG. 14 is a drawing showing a nut stopper of a wedge handling unit applied to a mounting structure for a drive shaft assembly according to an embodiment.

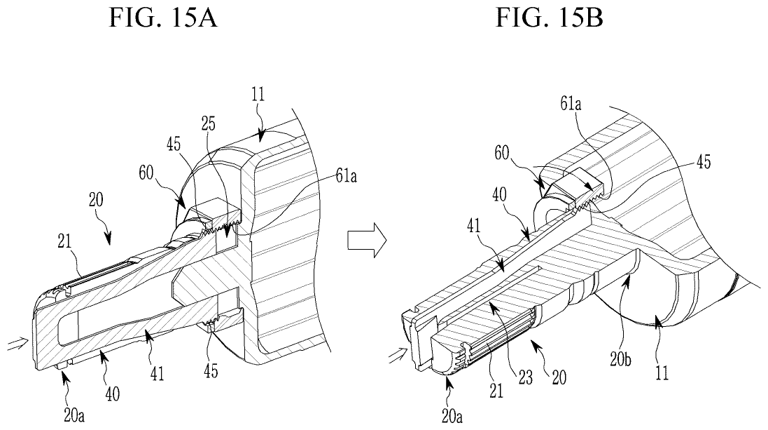

FIG. 15A and FIG. 15B are cutaway views showing the connection process of a wedge stay and a wedge handling unit applied to a mounting structure for a drive shaft assembly according to an embodiment.

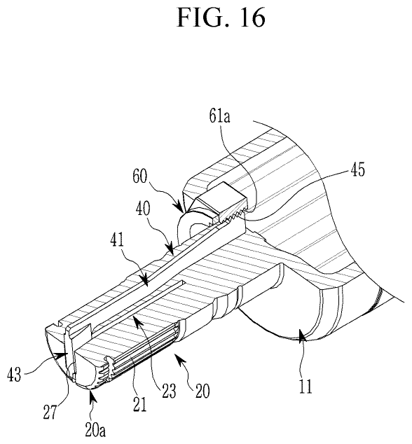

FIG. 16 is a cutaway view showing the completed connection of a wedge stay and a wedge handling unit applied to a mounting structure for a drive shaft assembly according to an embodiment.

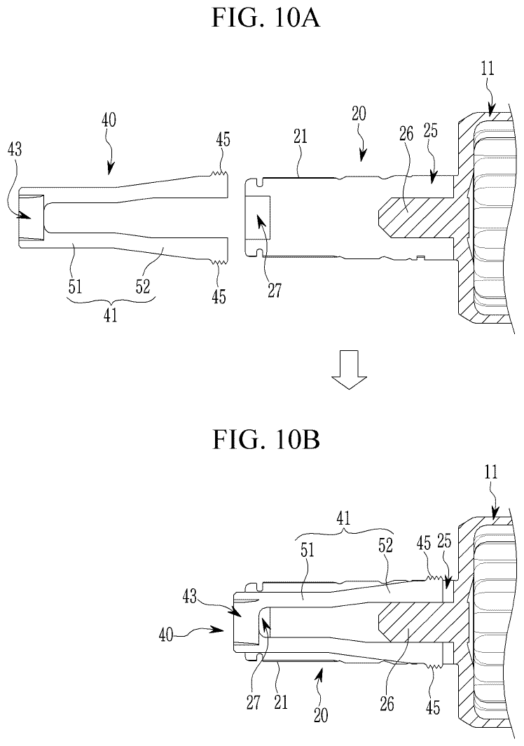

Referring to FIG. 10A to FIG. 16, an embodiment of the wedge handling unit 60 includes a fastening nut 61 and a nut stopper 63.

The fastening nut 61 is rotatably mounted on the connecting end portion 20b side of the stem portion 20 and is screwed into the screw tap part 45 of the wedge stay 40.

The nut stopper 63 is configured to support the fastening nut 61 on the connecting end portion 20b side of the stem portion 20. The nut stopper 63 is provided in a ring shape and is provided on the connecting end portion 20b side of the stem portion 20.

The nut stopper 63, as shown in FIG. 14, includes at least one key protrusion 71 and at least one guide groove 73.

The at least one key protrusion 71 is formed to protrude along the interior diameter direction on the inner surface of the nut stopper 63. The at least one key protrusion 71 may be fitted along the axial direction to the cut line 23 of the stem portion 20 and the guide rail 25. The at least one key protrusion 71 may be formed as a pair on the inner surface of the nut stopper 63, in one example.

At least one key protrusion 71 is key-coupled to the key groove 29 of the stem portion 20 as mentioned above along the rotating direction of the fastening nut 61, and may be fixed to the connecting end portion 20b side of the stem portion 20.

And, the at least one guide groove 73 is configured to guide the wedge body portion 41 of the wedge stay 40, which is joined to the cut line 23 of the stem portion 20 and the guide rail 25.

The at least one guide groove 73 is formed on the inner surface of the nut stopper 63. The at least one guide groove 73 may be formed as a pair on the inner surface of the nut stopper 63, in one example.

According to the wedge handling unit 60 configured as described above, the fastening nut 61 may be rotatably provided on the connecting end portion 20b side of the stem portion 20.

As shown in FIG. 15, the wedge body portion 41 of the wedge stay 40 is inserted along the axial direction into the cut line 23 and the guide rail 25.

By rotating the fastening nut 61, the screw tap part 45 of the wedge stay 40 may engage with the screw thread 61a of the fastening nut 61.

That is, if the fastening nut 61 is rotated in one direction (e.g., clockwise direction), the screw tap part 45 may be screwed into the screw thread 61a of the fastening nut 61.

And, when the fastening nut 61 continues to rotate in one direction, the wedge stay 40 may move from the free end portion 20a of the stem portion 20 to the connecting end portion 20b along the cut line 23 and the guide rail 25.

Accordingly, when the wedge stay 40 moves as described above, as shown in FIG. 16, the wedge protrusion 43 of the wedge stay 40 may be wedge-connected to the wedge connection groove 27 of the stem portion 20.

Hereinafter, the assembly process and operation of the mounting structure for a drive shaft assembly 100 according to an embodiment configured as described above will be described in detail with reference to the accompanying drawing.

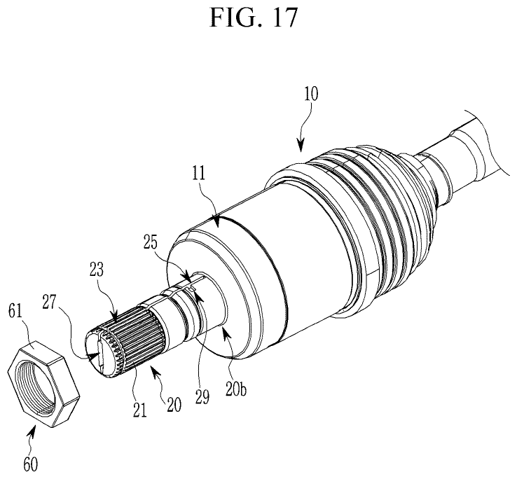

FIG. 17 to FIG. 24 are drawings for explaining the assembly process and operation of a mounting structure for a drive shaft assembly according to an embodiment.

Referring to FIG. 17, the drive shaft assembly 10 is provided. The drive shaft assembly 10 includes the outer wheel 11 rotatably mounted on the shaft 13 via the joint 12 (see FIG. 3).

The drive shaft assembly 10 includes the stem portion 20 formed protruding from the closed end of the outer wheel 11. The stem portion 20 includes the serration 21, the cut line 23, the guide rail 25, the wedge connection groove 27, and the key groove 29.

With the drive shaft assembly 10 as described above provided, the fastening nut 61 of the wedge handling unit 60 is provided on the connecting end portion 20b side of the stem portion 20.

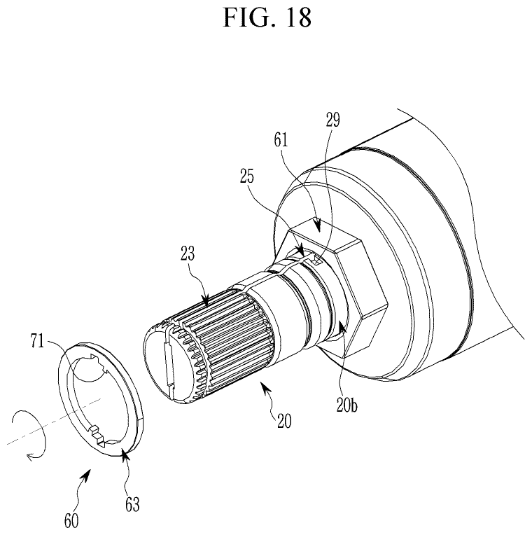

As shown in FIG. 18, the nut stopper 63 of the wedge handling unit 60 is fixed to the connecting end portion 20b side of the stem portion 20.

The nut stopper 63 is fitted along the axial direction to the cut line 23 of the stem portion 20 and the guide rail 25 through at least one key protrusion 71.

Then, the nut stopper 63 is rotated in one direction. Accordingly, the nut stopper 63 may be fixed to the connecting end portion 20b side of the stem portion 20 while the at least one key protrusion 71 is key-engaged in the key groove 29.

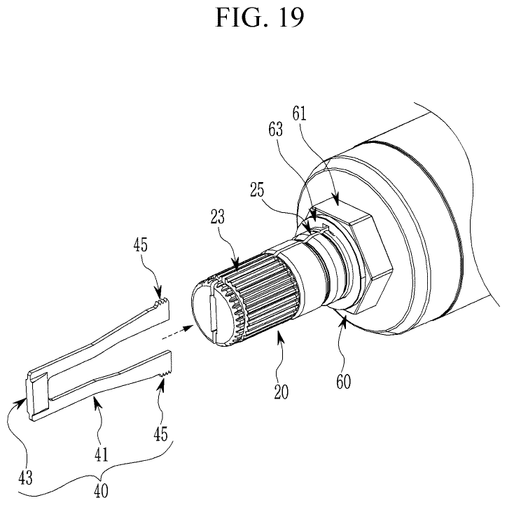

As shown in FIG. 19, the wedge stay 40 is provided, which includes the wedge body portion 41, the wedge protrusion 43, and the screw tap part 45. The wedge stay 40 is fitted along the axial direction to the cut line 23 and the guide rail 25 of the stem portion 20.

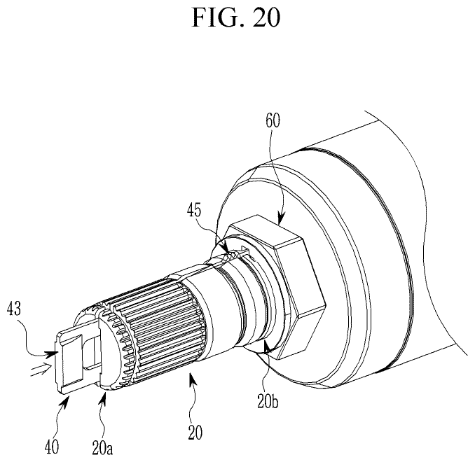

As shown in FIG. 20, the wedge protrusion 43 is positioned on the free end portion 20a side of the stem portion 20, and the screw tap part 45 is positioned on the connecting end portion 20b side of the stem portion 20.

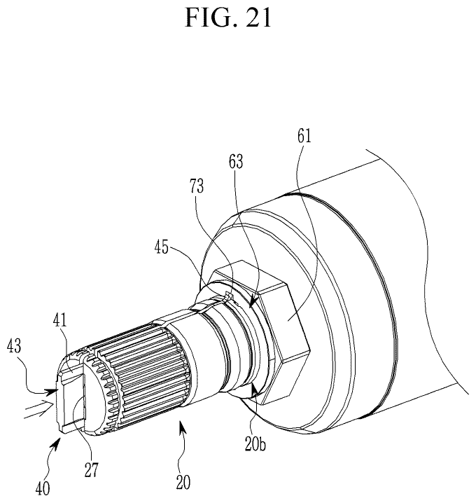

As shown in FIG. 21, when the wedge body portion 41 is pushed further toward the connecting end portion 20b of the stem portion 20, the wedge protrusion 43 is positioned in the wedge connection groove 27 of the stem portion 20. Additionally, the screw tap part 45 is adjacent to the screw thread 61a of the fastening nut 61 through at least one guide groove 73 of the nut stopper 63.

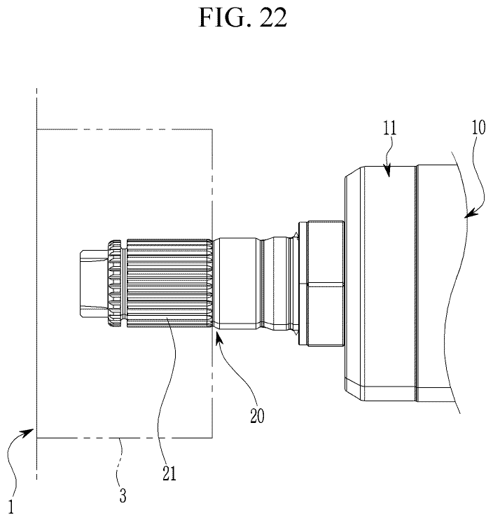

As illustrated in FIG. 22, the drive shaft assembly 10 is coupled to the differential unit 1.

The outer wheel 11 of the drive shaft assembly 10 is spline coupled to the side gear 3 of the differential unit 1 via the stem portion 20. The gear teeth of the side gear 3 are spline-connected along the axial direction with the serration 21 of the stem portion 20.

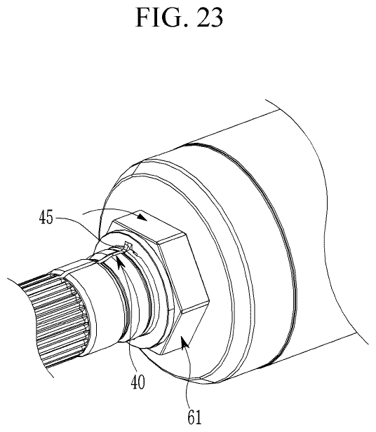

As shown in FIG. 23, the fastening nut 61 is rotated in one direction, for example, the clockwise direction.

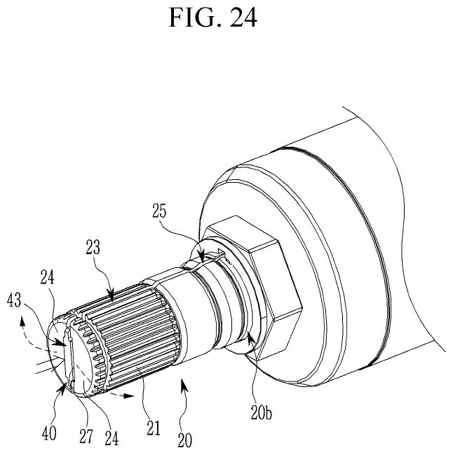

Then, since the screw tap part 45 is connected to the screw thread 61a of the fastening nut 61, the screw tap part 45 engages with the screw thread 61a of the rotating fastening nut 61. Accordingly, the wedge stay 40 is moved toward the connecting end portion 20b of the stem portion 20 along the cut line 23 and the guide rail 25, as shown in FIG. 24.

As the wedge stay 40 moves as described above, the wedge protrusion 43 of the wedge stay 40 is wedge-connected to the wedge connection groove 27 of the stem portion 20.

Since the wedge protrusion 43 is formed with the gradient angle θ2 greater than the gradient angle θ1 of the wedge connection groove 27, the stem portion 20 is extended through the cut line 23. That is, the wedge deformable parts 24 of the stem portion 20 are spread apart by the wedge protrusion 43.

Therefore, since the serration 21 of the stem portion 20 is in close contact with the gear teeth of the side gear 3 of the differential unit 1, the stem portion 20 and the side gear 3 may be engaged without any play (clearance) between the gear teeth.

Accordingly, the mounting structure for a drive shaft assembly 100 according to an embodiment can improve the backlash between the differential unit 1 and the drive shaft assembly 10, thereby minimizing the occurrence of backlash noise.

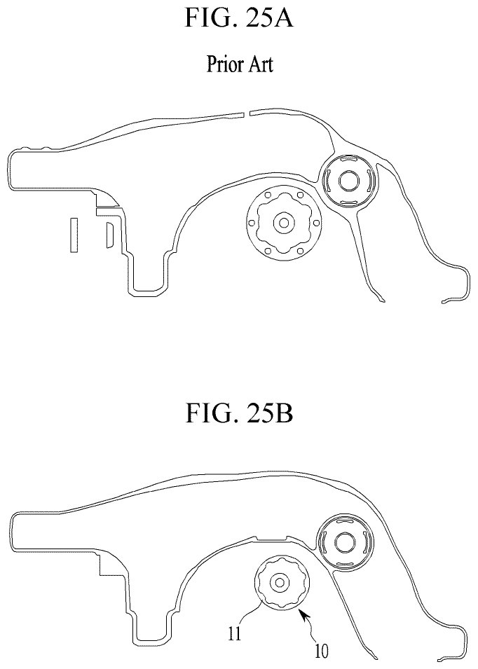

FIG. 25A and FIG. 25B are drawings illustrating the operational effects of a mounting structure for a drive shaft assembly according to an embodiment.

Compared to the mounting structure for a drive shaft assembly according to an embodiment illustrated in FIG. 25B and the general mounting structure for a drive shaft assembly illustrated in FIG. 25A, backlash can be improved without having to increase the size of the outer wheel 11.

Therefore, the mounting structure for a drive shaft assembly 100 according to an embodiment is advantageous for the package layout of a vehicle, can avoid interference with surrounding components (e.g., subframe), and can reduce weight and manufacturing cost.

Furthermore, since the mounting structure for a drive shaft assembly 100 according to an embodiment is advantageous for the package layout of a vehicle, it can also be applied to a dedicated platform for an electric vehicle.

On the other hand, according to the mounting structure for a drive shaft assembly 100 according to an embodiment, when the fastening nut 61 is rotated in the opposite direction, for example, in the counterclockwise direction, the wedge stay 40 can be moved from the connecting end portion 20b side to the free end portion 20a side of the stem portion 20. That is, in this case, the wedge connection of wedge stay 40 to the stem portion 20 can be released.

Accordingly, according to the mounting structure for a drive shaft assembly 100 according to an embodiment, since the drive shaft assembly 10 and the differential unit 1 can be easily separated, A/S such as maintenance and replacement of the drive shaft assembly 10 can be easily performed.

Although the present disclosure has been described above with regard to a preferably embodiment thereof, the present disclosure is not limited thereto, and it is possible to implement the present disclosure by modifying it in various ways within the scope of the patent claims and the detailed description and accompanying drawings of the disclosure, and this also naturally falls within the scope of the present disclosure.

What is claimed is:

1. A mounting structure for a drive shaft assembly, which is configured to mount a drive shaft assembly including an outer wheel to a differential unit, the mounting structure comprising:
a stem portion protruding from the outer wheel and connected to the differential unit, the stem portion having a cut line formed along an axial direction at a free end portion; and
a wedge stay configured to be wedge-attachable along the axial direction of the stem portion on the cut line.

2. The mounting structure of claim 1, further comprising a wedge handling unit mounted on the stem portion configured to engage the wedge stay on the cut line.

3. The mounting structure of claim 1, wherein:
the stem portion is extended outward by the wedge stay which is joined to the cut line; and
a serration formed on an exterior circumference surface of the stem portion which adheres to a side gear of the differential unit.

4. The mounting structure of claim 1, wherein the cut line extends from the free end portion of the stem portion to a predetermined section along the axial direction.

5. The mounting structure of claim 4, wherein the stem portion comprises a guide rail connecting the cut line and a connecting end portion connected to the outer wheel.

6. The mounting structure of claim 1, wherein the stem portion comprises a plurality of wedge deformable parts cut along the axial direction by the cut line.

7. The mounting structure of claim 2, wherein the stem portion comprises a wedge connection groove formed in the free end portion direction of a plurality of wedge deformable parts.

8. The mounting structure of claim 7, wherein the wedge stay comprises:
a wedge body portion fitted along the axial direction of the cut line;
a wedge protrusion formed at one end of the wedge body portion and joined to the wedge connection groove; and
a screw tap part formed on an other end of the wedge body portion.

9. The mounting structure of claim 8, wherein the wedge body portion is formed as a U-shaped plate.

10. The mounting structure of claim 8, wherein the wedge connection groove is formed with a predetermined gradient angle θ1 having a cross-section that decreases from the free end portion of the stem portion to a connecting end portion direction.

11. The mounting structure of claim 10, wherein the wedge protrusion is formed by a gradient angle θ2 greater than the gradient angle θ1 of the wedge connection groove, having a cross-section that decreases from one end of the wedge body portion to the other end of the wedge body portion.

12. The mounting structure of claim 8, wherein the wedge handling unit comprises a fastening nut rotatably mounted on a connecting end portion side of the stem portion and being screw-connected with the screw tap part.

13. The mounting structure of claim 12, wherein the wedge handling unit further comprises a nut stopper having a ring shape and being positioned on the connecting end portion side of the stem portion.

14. The mounting structure of claim 13, wherein the nut stopper comprises:
at least one key protrusion protruding along an interior diameter direction on an inner surface of the nut stopper so as to fit along the axial direction of the stem portion on the cut line; and
at least one guide groove formed on the inner surface configured to guide the wedge body portion.

15. The mounting structure of claim 14, wherein:
a key groove connected to the cut line is formed on the connecting end portion side of the stem portion; and
the at least one key protrusion is coupled to the key groove along a rotating direction of the fastening nut.

16. The mounting structure of claim 12, wherein by rotation of the fastening nut that is screw-connected with the screw tap part, the wedge stay is configured to move from the free end portion to a connecting end portion of the stem portion.

17. The mounting structure of claim 16, wherein the wedge protrusion is joined to the wedge connection groove by movement of the wedge stay.
